(19) United States
(12) Patent Application Publication
(10) Pub. No.: US 2002/0197369 A1
(43) Pub. Date: Dec. 26, 2002

(54) APPARATUS AND METHOD FOR PRODUCING SOFT PROTEIN FOODS

(76) Inventor: H. WAYNE MODLER, KEMPTVILLE (CA)

Correspondence Address: RALPH A DOWELL, DOWELL & DOWELL, 1215 JEFFERSON DAVIS HIGHWAY, SUITE 309, ARLINGTON, VA, 22202-3124, US

(21) Appl. No.: 09/463,487

(22) PCT Filed: Jul. 27, 1998
(86) PCT No.: PCT/CA98/00723

(30) Foreign Application Priority Data
Jul. 25, 1997 (CA) 2211453

(51) Int. Cl. C12C 7/28

(52) U.S. Cl. 426/522

(57) ABSTRACT

An apparatus for the continuous production of soft protein foods wherein the liquid protein source remains enclosed, passing through a heat exchanger followed by one or more holding tubes, passing into coagulation tubes. The product exits onto a perforated conveyor belt, permitting drainage of a liquid by-product. This invention also includes processes for producing various soft protein foods such as acid-curd cheeses, whey cheeses, soyfood, and casein.

### FIELD OF THE INVENTION

This invention relates to an apparatus and to processes for the continuous production of soft protein foods, such as soft cheeses, tofu, and casein.

### BACKGROUND OF THE INVENTION

There is a number of foodstuffs that can be produced through the coagulation of proteins from a liquid. Examples include cheese, casein, and soyfood.

Cheesemaking involves the coagulation of milk, skim milk, ultrafiltered (UF) milk, cream, nonfat dry milk, whey, or combinations thereof. Casein (a milk protein) is obtained by its coagulation from skim milk. Tofu, a soybean product, is coagulated from soymilk.

Conventional small-scale equipment for the production of soft protein foods is essentially batch processing equipment wherein each of the processes is performed sequentially in large vats. Such equipment is normally open to the air, increasing the risk of contamination and resulting in fluctuations in both quality and shelf-life. This conventional design also minimizes the ability to clean-in-place. In addition, such equipment is labour intensive.

The more automated semi-continuous methods are still based largely on batch processes. The cooker/pressure vessels are fed batch-by-batch and the product is discharged before a new batch is added.

There are a few continuous methods in use. However, all existing totally self-contained units are based on “open” traditional methods and still pose greater risk for contamination and are more labour-intensive than the current invention. Panzer et. al. (16) produced Cottage cheese by a continuous process; Nolan (15) describes the continuous production of cheese-based material from milk.

Alfa Laval devised the “Alcurd” continuous cheese process using ultrafiltered milk (1 and UK Patent 1,206,011). This process differs from the current invention in the following respects: (i) The process is not truly continuous. Instead, the Alcurd patent teaches the coagulation tube is filled with ultrafiltered milk (not whey or a whey/milk blend) and then it stays in a quiescent condition for 20 to 30 minutes before fresh milk is pumped into the tube to displace the enzymatically coagulated curd; (ii) The Alcurd process was designed for the production of renneted cheese and also contains a bacterial culture. Normally the culture and rennet are blended in just before entry into the coagulation tube. The process of the current invention uses neither culture nor enzyme; and (iii) The Alcurd process incorporates an ultrafiltration (UF) step and once the starter culture and rennet are added, the coagulation process commences. Once the coagulated curd is pushed from the tube, very little deproteinated whey (DP) is expelled. In the process of the current invention, DP is a major by-product of the process.

Sordi (IT 01244289) describes an apparatus for the continuous production of ricotta cheese. While the Sordi process has some similarities to the current invention, e.g., continuous heating, salt addition, acid addition and curd removal, the current invention differs in several respects: (i) The current process does not rely on the air for curd flotation as the Sordi patent teaches. As a result, the Sordi patent does not teach the production of whole milk ricotta with their equipment as the curd will sink to the bottom of the vat; (ii) The Sordi process has lower yields than the current process, because some of the coagulated protein, particularly, α-lactalbumin will sink to the bottom. In the current process the “plug flow” of curd serves to remove all particles, large or small, from the coagulation tube on a continuous basis; (iii) The Sordi process has a series of paddles to push the curd onto the conveyor. This can result in microbial contamination and makes cleaning exceptionally difficult; (iv) The current process has higher levels of energy regeneration, lower capital costs and reduced chemical costs for cleaning; and (v) Acid injection in the Sordi process is not described in terms of “point of injection”. A current process has a specific device for mixing acid with the incoming liquid (milk/whey blend or any combination thereof), i.e., the fluted device.

APV Canada describes a process (1993, Bulletin No. D793.07.20) for the continuous production of Ricotta. The process differs from the current invention as described: (i) All the deproteinated whey (DP) is removed up-front by means of ultrafiltration (product is actually called permeate) before the heating process is initiated; and (ii) The APV process yields a curd which has a higher calcium content. As a result it is grainy in texture and is somewhat chalky in taste. This process has never been widely used because of these defects.

Improvements have been made in the area of curd collection. Calabro (4) partially automated the curd-whey separation process by allowing the deproteinated whey to drain through a perforated conveyor belt. The equipment described by Calabro (4) contained two vats of over 2,000 lb capacity in which milk was heated and acidified in batches, then pumped onto a perforated screen for separation. The equipment was costly and curd was subjected to undesirable agitation during pumping, leading to loss of product during draining. Savarese (22) described equipment in which the coagulated curd was continuously removed from the surface of the milk-containing liquid and directed through an exit port in the tank sidewall; however, agitation at the top of the tank was undesirable, as it disrupted curd formation and reduced cheese yield. In addition, there was no assurance that all of the whey proteins were fully denatured thereby leading to reduced product yield. Pontecorvo reveals that curd collection can be improved by placing a reducing neck at the top of the vat and raising the liquid level to assist in curd collection and removal (19). The curd could also be removed by placing adjacent baskets in the vat bottom, draining the whey, and then removing the baskets (18). In a subsequent invention, Pontecorvo improvised a vat that facilitated deproteinated whey removal through a series of separate tubular strainers contained side-by-side in a pan forming the bottom of the vat (20). The pan was subsequently detached and transported to an unloading zone and the strainers were removed for discharging of the curd. Carswell (5) used a fine mesh screen for removal of deproteinated whey, but the same result could be obtained by placing the curd in individual perforated hoops (2). Bed filtration was also used to collect the curd but the quantity of curd collected was limited by the “cake” volume of the filter press making this a batch operation (6).

Additional techniques have also been devised to alter curd characteristics. Lavarda (12) described a process where the curd settled to the bottom of the vat and the clear whey was drained off rather than having to scoop curd from the surface. Schmidt (23) used two stage heating and calcium addition to prepare Ricotta cheese. Other methods of producing Ricotta-like cheese include the method of Edwards (7), whereby skimmilk was heated and acidified and the curd removed. The curd was then comminuted and blended with cream.

### SUMMARY OF THE INVENTION

It is an object of the current invention to provide an apparatus and related processes for the production of soft protein foodstuffs. Such foodstuffs can be produced from any liquid protein source which can be coagulated. Examples of soft-protein foods that can be produced with the apparatus of the current invention include: fresh cheeses, soyfoods, and casein.

Each of the above-mentioned processes have limitations and fail to either produce the desired product, have high product losses, are batch systems, or use expensive or complicated equipment. The aims of the current invention include a consistently high quality product, ease of on-site assembly, major reductions in waste, recycling of heat generated within the totally self-contained processes, reduced labour versus conventional methodology, fully automated system with ease of handling and continuous quality control capability, minimal risk of product contamination due to totally self-contained processes resulting in a product having a longer shelf life on average, self-contained continuous clean-in-place capabilities, and higher yields which provide major economic benefits. The apparatus of the patent invention is the first apparatus which uses a truly continuous process for the production of soft protein foods. Finally, this is the first apparatus described which has the flexibility to be used to produce a number of soft protein foods and is not limited to one product only.

Therefore, this invention seeks to provide an apparatus for making soft protein foods including:

a liquid protein supply tank;

an enclosed first channel-way communicating between the liquid protein supply tank and a heat exchanger;

at least one source of heat for the heat exchanger;

an enclosed second channel-way adapted to transport heated liquid protein from the heat exchanger to first holding tube;

the first holding tube adapted, in operation, to maintain the heated liquid protein therein at a predetermined temperature for a prescribed period of time;

a third channel-way adapted to transport liquid protein between the holding tube and a manifold;

the manifold communicating with a plurality of enclosed coagulation lines, each coagulation line adapted, in operation, to permit coagulation of liquid protein therein to obtain coagulated protein and liquid waste; and

the apparatus further including:

a coagulant supply means and at least one injection means adapted to introduce coagulant from the coagulant supply means into each coagulation line, and the coagulation line being adapted, in operation, to deliver coagulated protein and liquid waste to an exit port;

means for separating the liquid waste from the coagulated protein delivered through the exit port; and

a plurality of pumps adapted, in operation, to transport liquid protein through the apparatus.

The invention further seeks to provide a method of making Ricotta cheese comprising the steps of:

continuously metering and measuring predetermined quantities and ratios of milk and whey;

mixing said milk and whey in a blending mixer;

adjusting the pH of said milk and whey mixture by the addition of alkali to a pH of approximately 6 to 8;

heating said mixture in a heat exchanger;

transporting said heated mixture through a first holding tube;

maintaining said heated mixture at approximately 80-100 degrees C. in said holding tube for about 1 minute;

moving said heated mixture to a second holding tube;

maintaining said mixture in said second holding tube at approximately 60-90 degrees C. for up to 20 minutes in order to denature said whey protein;

transporting said mixture through a manifold into a plurality of tubes;

adding food grade acidulant to said mixture in a predetermined quantity passing the acidulant and the mixture with a laminar flow coagulation tube to effect coagluation of the mixture into coagulated protein and deproteinized whey;

delivering said coagulated protein and deproteinized whey from said laminar flow tube; and

separating coagulated protein to provide the Ricotta cheese product.

This invention also seeks to provide a method of making tofu comprising the steps of:

measuring a predetermined quantity of a solution containing soymilk;

heating soymilk solution in a heat exchanger;

transporting said heated solution through a holding tube;

maintaining said heated solution at approximately 95° C. in said holding tube for about 1 minute;

transporting said solution through a manifold into a plurality of tubes;

in each said tube adding a food grade coagulant selected from the group consisting of mineral salt and organic acid, to said soymilk solution in a predetermined quantity;

passing the coagulant and the solution into a laminar flow coagulation tube to effect coagulation of the solution into coagulated soyfood and deproteinized liquid waste;

delivering the coagulated soyfood and deproteinized liquid waste from said laminar flow tube; and

separating coagulated soyfood to provide the tofu product.

This invention also seeks to provide A method of making casein comprising the steps of:

measuring a predetermined quantity of skim milk;

heating said skim milk in a heat exchanger;

transporting said heated skim milk through a holding tube;

maintaining said heated skim milk at approximately 29-48° C. in said holding tube for about 1 minute;

transporting said skim milk through a manifold into a plurality of tubes;

in each said tube, adding an acid selected from the group consisting of a mineral acid and an edible grade organic acid to said skim milk in a predetermined quantity;

passing the acid and the milk into a laminar flow coagulation tube to effect coagulation of the milk into coagulated protein and deproteinized whey;

delivering said coagulated protein and deproteinized whey from said laminar flow tube; and

separating coagulated product to provide the casein.

In another aspect, this invention provides a method of making Queso blanco cheese comprising the steps of:

continuously metering and measuring predetermined quantities and ratios of milk and whey;

mixing said milk and whey in a blending mixer;

heating said mixture a heat exchanger;

transporting said heated mixture through a first holding tube;

maintaining said heated mixture at approximately 80-100 degrees C. in said holding tube for about 1 minute;

moving said heated mixture to a second holding tube;

maintaining said mixture in said second holding tube under predetermined temperature for up to 20 minutes in order to denature said whey protein;

transporting said mixture through a manifold into a plurality of tubes;

into each said tube adding food grade acidulant to said mixture in a predetermined quantity;

passing the acidulant and the mixture into a laminar flow coagulation tube to effect coagulation of the mixture into coagulated protein and deproteinized whey;

delivering said coagulated prtein and deproteinized whey from said laminar flow tube; and

separating coagulated protein to provide Queso blanco.

### BRIEF DESCRIPTION OF THE DRAWINGS

These and other objects, features, and many of the attendant advantages of the invention will be better understood upon a reading of the following detailed description of the invention when considered with the accompanying drawings herein.

FIG. 1 demonstrates the relative positioning of FIGS. 1A, 1B, and 1C.

FIG. 1A is an expanded schematic drawing of a first portion of said apparatus.

FIG. 1B is an expanded schematic drawing of a second portion of said apparatus.

FIG. 1C is an expanded schematic drawing of a third portion of said apparatus.

FIG. 2 is a partial longitudinal cross-section of chamber 56 shown in FIG. 1C.

FIG. 3 demonstrates the relative positioning of FIGS. 3A and 3B.

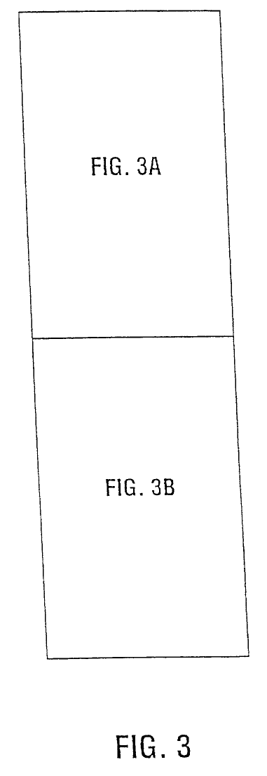

FIG. 3A is a schematic drawing of a first part of continuous ricotta production.

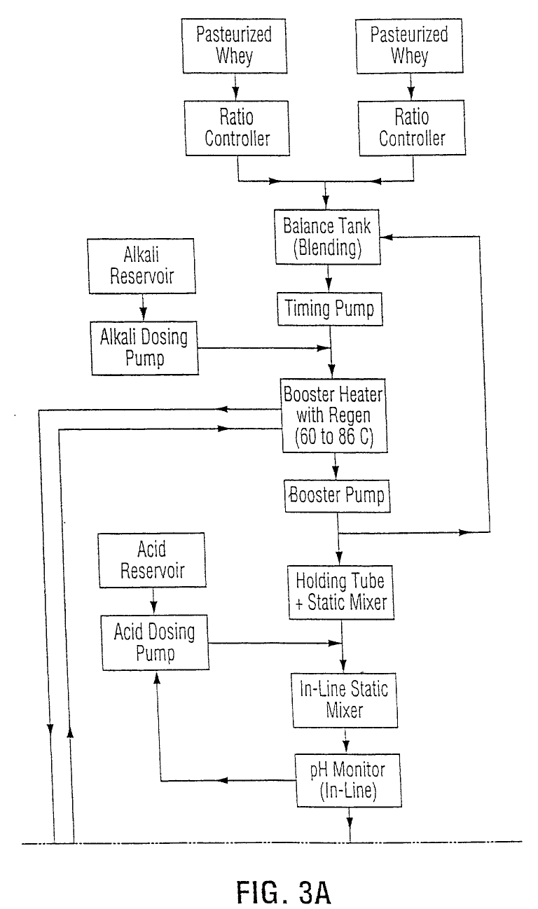

FIG. 3B is a schematic drawing of a second part of continuous ricotta production.

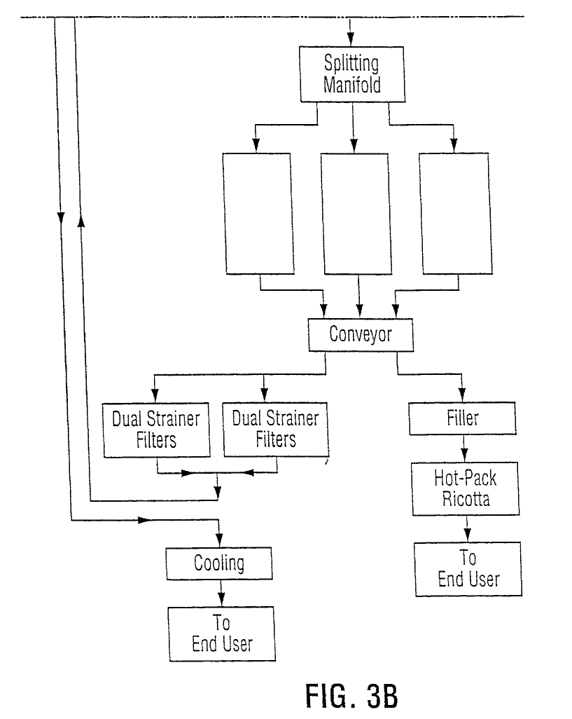

FIG. 4 is a flow sheet for tofu manufacturing.

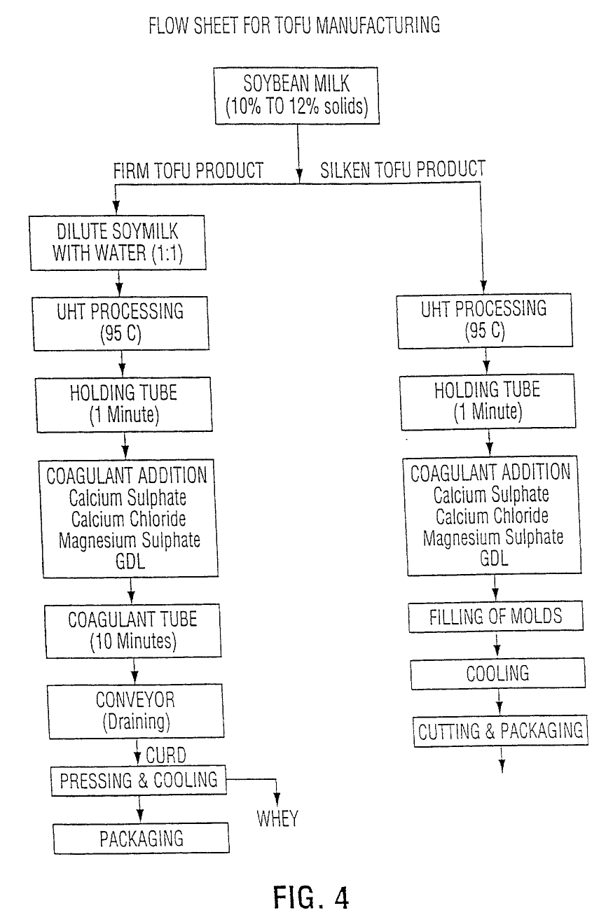

The numbers indicated in the above figures refer to the following:

1. liquid protein supply tank

2. liquid protein or water supply tank

3. deproteinized liquid

4. supply pipes

5. valves

6. pump

7. flow meters

8. ratio meter

9. metering line

10. cream port

11. in-flow line

12. balance tank

13. outlet port

14. out-flow

15. pump

16. alkali tank

17. alkali pump

18. pH controller

19. alkali in-flow line

20. static mixer

21. pH sensor

22. salt injection port

23. sample port

24. product in-flow line

25. heat exchanger

26. hot deproteinated liquid

27. pump

28. deproteinated liquid collection tank

29. hot water inlet line

30. out-flow line (to 3 or to sewer)

31. out-flow line

32. sample port

33. flow meter

34. first holding tube

35. out-line

36. temperature gauge

37. flow diversion meter

38. control panel

39. return flow line

40. 2nd return flow line

41. out-flow line

42. divert panel

43. out-flow line

44. second holding tube

45. out-flow line

46. temperature gauge

47. out-flow line

48. salt tank

49. salt pump

50. injection port

51. manifold

52. coagulation line

53. coagulation line

54. coagulation line

55. coagulation line

56. coagulant/protein mixing chamber

57. coagulant tank

58. injector

59. coagulant out-flow line

60. pump

61. pump

62. pump

63. pump

64. injector

65. injector

66. injector

67. injector

68. coiled coagulation line

69. coiled coagulation line

70. coiled coagulation line

71. coiled coagulation line

72. conveyor

73. plate heat exchanger (for cooling whey)

74. in-flow line

75. coagulant injector

76. liquid protein entrance orifice

77. casing

78. mixing chamber

79. coagulant entrance area

80. plate

81. exit port

82. exit port

83. exit port

84. exit port

### DETAILED DESCRIPTION OF THE INVENTION

The current invention can be used to produce soft protein foods from any liquid protein source which can be coagulated. Examples of soft-protein foods that can be produced with the apparatus of the current invention include: fresh cheeses, tofu, and casein.

In terms of cheeses, the apparatus is best suited to making acid-curd fresh cheeses and whey cheeses which are made by adding a food grade organic acid (the coagulant), allowing the proteins to coagulate and then draining the whey. Such cheeses can be made with any type of milk or whey from a variety of mammals including cow, ewe, goat, and buffalo, or mixtures thereof. Acids that can be used to induce coagulation include organic acids, and more specifically include lactic, citric, and acetic acid. Such cheeses include among others: Ricotta, Paneer, Queso Blanco and other related Latin American cheeses, Cream Cheese, Handkaese, Gervais, Korbkaese, Nieheimer, Olmuetzer Quargel, Quark, Rahmfrischkaese, Requeij\overline{a}o, and Twrog.

Examples 1-3 describe the production of typical Ricotta. Ricotta is a soft creamy product with a slight caramel flavor and traditionally has been prepared from “sweet” whey such as Cheddar, Swiss or Provolone (11). Ricotta is often made from a blend of whey and 5 to 35% whole milk. Traditional no-fat versions of Ricotta include Ricotone, a Ricotta produced only from whey with no added milk nor other casein-containing components, and Impastata Ricotta made from skimmilk. Another type is known as Impastata which is prepared using whole or partly skimmed milk. This product, higher in lactose, has a bland acid flavor, desirable for use in fine pastry (9). Examples 4 and 5 describe the production of goat's whole milk Ricotta.

Examples 8 and 9 describe the production of Queso Blanco which is a Latin American cheese manufactured from whole milk or milk standardized to approximately 3% butterfat. Other types of Latin American cheeses that can be prepared by means of this invention include Queso de Hoja, Queso de Puna, Queso de Prensa, Queso del Pais and Queso Fresco (10). Paneer, an Indian cheese, can also be prepared with this apparatus. It is made by adding soured whey or lemon juice to hot milk, and straining the curds produced.

Casein is the major protein found in milk, accounting for 78% of all milk protein. It is widely used in cheese, plastics, paints, and adhesives. It is normally produced by adding a coagulant in the form of an acid (mineral or organic) to skim milk and heating to precipitate the casein from solution. It is then drained and washed. Its production is described in Example 6.

Tofu is a soybean product, often used in Asian cuisine. Traditionally it is made by soaking soybeans in water, pulverizing the soybeans to make “soybean milk”, adding a coagulant which is a mineral salt such as chloride or sulphate salts of calcium or magnesium, heating the mixture to coagulate the proteins and then draining away the liquid by-product from the tofu product. There are several types of tofu including firm tofu and silken tofu. The production of firm tofu is described in Example 7.

The processes of this invention for making soft protein foods all involve one or more of the following steps: blending of ingredients, pH adjustment, heating, addition of coagulant, coagulation, salt and water addition, and removal of liquid by-product.

1) Blending of Ingredients

The apparatus is made up of at least one, often two holding tank(s) where the liquid protein (coagulated protein precursors) are stored. These holding tank(s) is/are connected to a blending tank by means of (an) enclosed channel-way(s) along which there may be a flow meter. The ingredients are moved along the channel-way(s) by means of (a) pump(s). In the case where there is more than one holding tank, the contents of which one wishes to blend, the aforesaid flow meters may be connected to a ratio meter, so that the ratio of the ingredients can be adjusted as desired. When there is more than one starting ingredient, the multiple channel ways are joined together into one enclosed channel-way which leads into the blending tank. If cream is required, this is added into this last channel-way before the final ingredient mixture goes into the blending tank. The blending tank allows for the thorough mixing of the starting ingredients.

In the case of cheese and tofu production, there are often two liquid components that need to be mixed at the beginning of the process.

In the case of cow's milk Ricotta cheese, this would be some sort of whey (regular whey or UF whey), and a casein-containing ingredient such as skimmilk, skimmilk powder, casein, caseinates, whole milk, buttermilk, or UF retentates of skimmilk or whole milk. The casein-containing ingredients are added to increase curd strength and handling 10 characteristics. Ricotta can be prepared from whey only, but the yield is low and the curd fragile. Concentration of the protein in whey, by ultrafiltration, improves curd strength and increases yield. “Queso” type cheeses are normally prepared from either whole milk or milk standardized to a specific fat content, e.g. 3%. Blending skimmilk with whole milk can also be used to standardize fat content

In the case of tofu, one would either start with pure soymilk or mix soy milk with water.

In the case of casein, one starts with only one product, namely skim milk. Thus, no blending of ingredients is done in the first stage of the process.

2) pH Adjustment

The blending tank is hooked up be means of an enclosed channel-way to a plate heat exchanger. The ingredients are transported through this channel-way by means of a pump.

However, in the case of whey cheeses, this channel-way of the apparatus is additionally equipped with pH adjustment and monitoring devices and a mixer. A port into which is fed an alkaline solution is located in the channel-way after the blending tank. This solution is typically a ˜12.5N solution of NaOH. Within the channel-way, after the alkali injection port, is a static mixer followed by a pH metering device. Whey proteins are more extensively denatured above the isoelectric point. Therefore, the pH is commonly adjusted to 6.3 to 6.5 (8) to enable the whey proteins to be more completely denatured, and thus, more readily precipitate upon addition of the coagulant. In the current invention, the pH is adjusted as a function of what characteristics of the final product are desired. For example, the invention has been used with pH's of 7.0-7.5, which gives a softer curd.

pH adjustment before heating is not necessary in the manufacture of “Queso”-type cheeses, as the pH of milk is normally in the range of 6.7 to 6.8.

Also, in the cases of tofu production and of casein production, pH adjustment is not needed.

3) Heating

As mentioned above, the blending tank is hooked up by means of an enclosed channel-way to a plate heat exchanger. The product is run through the channel-way by means of a pump. In one embodiment of the invention the heat exchanger is partially heated by means of the hot liquid by-product waste after the coagulated protein is separated in the final step. In the case of the production of ricotta cheese, the by-product is deproteinized whey. In all cases, the heat exchanger communicates with one or more holding tubes, in which the temperature of the liquid protein may fall slightly, depending on the flow rate and the length of the tube chosen for the specific product desired. In any case, after the first holding tube, the temperature is monitored. If the temperature is not the temperature desired at this point, the liquid protein may be diverted back to the plate heat exchanger by means of a channel-way.

Heating is necessary in all production to bring the liquid protein to a temperature at which coagulation can properly take place upon addition of the coagulant.

When making whey cheeses, heating is additionally necessary to denature the whey proteins and render them susceptible to aggregation when the product is subsequently acidified. Denaturation is a time-temperature dependent relationship and temperatures in excess of 70° C. are commonly used. In the present invention, whey proteins are typically denatured by heating to approximately 86-88° C., followed by passage through one holding tube which lasts 1 minute and then by passage through a second holding tube for up to 20 minutes.

In the case of casein production, the liquid protein is heated to a temperature lower than that used for the production of whey cheeses and is typically in the range of ˜29-48° C. The product is moved through one holding tube only, for a period of approximately 1 minute.

In the case of tofu production, the liquid protein is heated to a temperature higher than that used for the production of whey cheeses and is typically ˜95° C. The product is moved through one holding tube only, for a period of approximately 1 minute.

4 Addition of Coagulant

After the product is in holding tubes it travels by means of a channel-way to a manifold which passes into at least two, often four coagulation tubes. The division into two or more coagulation tubes reduces the flow rate and changes from turbulent flow in the holding tube into laminar flow in the coagulation tubes. At the beginning of these coagulation tubes is an orifice plate and an injector for the injection of the coagulant.

In the case of Ricotta production, the coagulant is an edible grade acid, typically an organic acid such as citric or lactic acid. The acid is directly added to the product at a temperature above 60° C., preferably 78-88° C. as some cooling occurs in the product flow coming from the plate heat exchanger. The strength of the acid used is not critical; however, more dilute solutions tend to give less fluctuations in pH and are less corrosive making them easier to manipulate. The dilution of the product may be achieved by the volume addition of acid during acidification or addition of water and/or salt solution at the tine of or directly before or after acidfication (see below). The pH within the coagulation tubes for ricotta cheese should be in the range of pH 5.5-5.8.

In the case of casein production, the coagulant is usually an edible grade organic acid, such as lactic or citric acid. However, for non-edible grade casein, a mineral acid, such as sulfuric or hydrochloric acid is often used. The pH of coagulation falls in the range of pH 4.3-4.5.

Finally, in the case of tofu production, the coagulant is typically a mineral salt, such as the chloride and sulfate salts of calcium or magnesium. However, an organic acid such as citric, lactic or acetic acid can also be used. In the case of addition of lactic acid, the pH of coagulation should be about 5.4-5.8

5) Water and Salt Addition

As mentioned above, water and/or salt may be added with, before, or after, the addition of the coagulant. This not only has the effect of diluting the liquid stream, but, in addition, such additions have been observed to increase curd cohesiveness and handling characteristics of the curd. In addition, they may be added for the purpose of improving the taste of the final product. Sodium chloride and calcium chloride are preferred for these purposes.

6) Coagulation

Coagulation is achieved by pumping the hot product containing the coagulant through a tube with a predetermined internal diameter so as to provide a predetermined residence time.

In the case of cheese products, the high-casein ones require less holding time since the curd forms quickly and is more cohesive, which improves handling characteristics. The high whey protein-containing products present a softer and more fragile curd and longer holding times are required to facilitate more complete agglomeration of the curd particles. Too long a holding time can produce a cooked flavour and reduced moisture in the curd.

The traditional Ricotta cheese process depends on the presence of dissolved and entrapped gas to float the curd to the surface of the liquid. In the present invention, entrapped or dissolved gases are not required to facilitate curd recovery.

Coagulation of the proteins, commences immediately upon addition of the coagulant. The holding tube is designed to give a slow laminar flow without excessive shearing or turbulence so as to encourage aggregation of the precipitated protein into large discrete clusters that are easily separated from the liquid by-product. The protein precipitation phenomenon is essentially complete within a few seconds after addition of the coagulant. The remaining portion of the holding tube allows for the separation of liquid by-product from the precipitated protein.

The strength of Ricotta curd prepared only from whey can be improved if the whey is first ultrafiltered to increase the protein concentration. Whey normally contains about 0.8% protein but only about half of this is precipitable by heating and acidification. The remainder is composed of non-protein nitrogen (NPN) and proteose-peptone. By ultrafiltration, the true protein content can be increased to levels of 1 to 2% or 2.5 to 5 times the content normally present in whey. This increase in protein concentration results in a firmer coagulum with better handling and draining characteristics.

7) Separation of Liquid by-product from Coagulated Protein Product

In the present invention, the hot coagulated protein product is gently placed on a slow moving conveyor with openings of appropriate size so as to provide good liquid drainage and release of coagulated protein. The continuous conveyor belt can be designed so as to permit the liquid by-product to drain through the upper and/or lower layer of the continuous belt. Passage of the liquid by-product through the lower layer serves to wash small adhering coagulated protein particles of the lower layer and prevents plugging. Further, fine particles adhering to the lower portion of the continuous belt can be removed by the use of compressed air.

8) Further Optional Features

a) Addition of cream: In the manufacture of certain cheeses, the addition of cream may be desirable. The apparatus provides for an optional cream port located shortly before the blending tank.

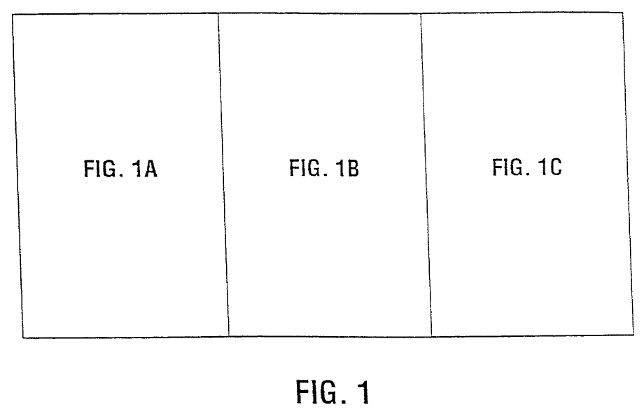

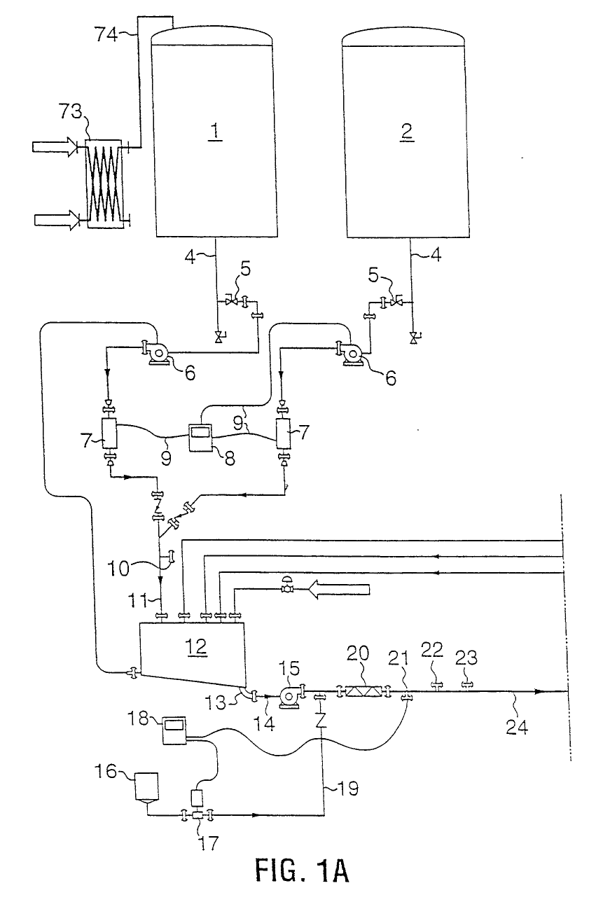

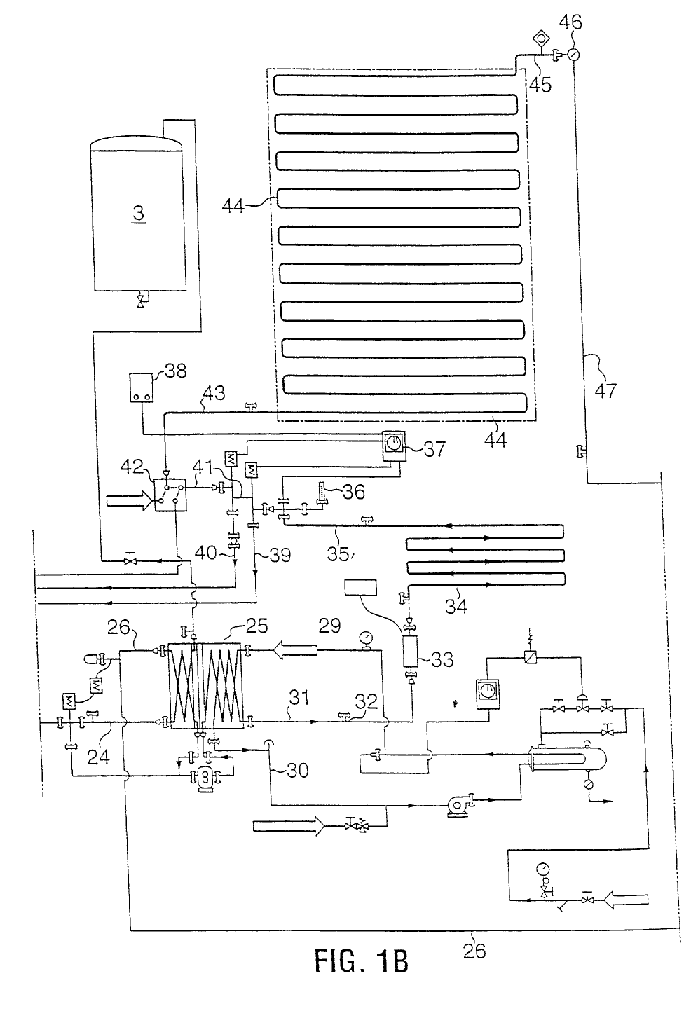

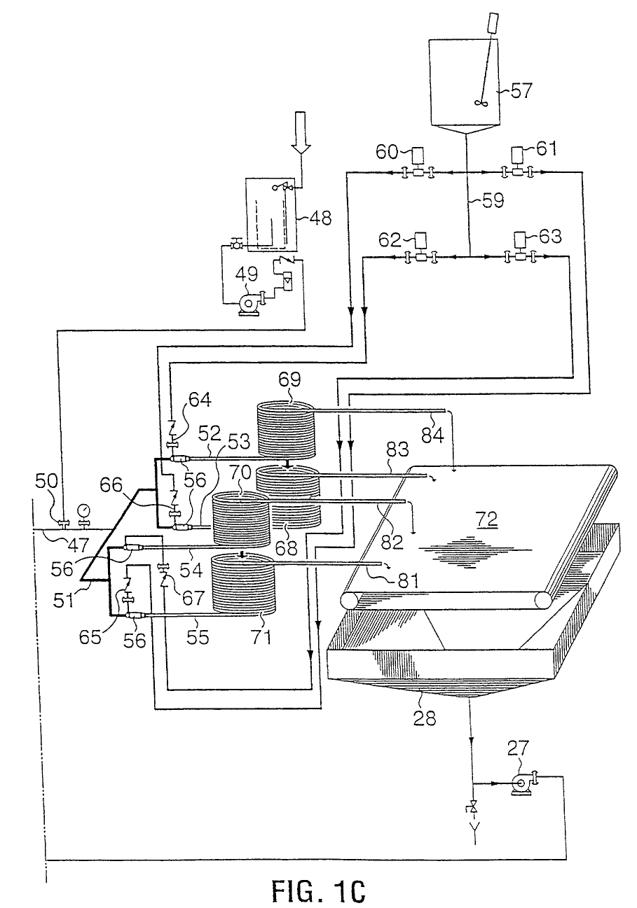

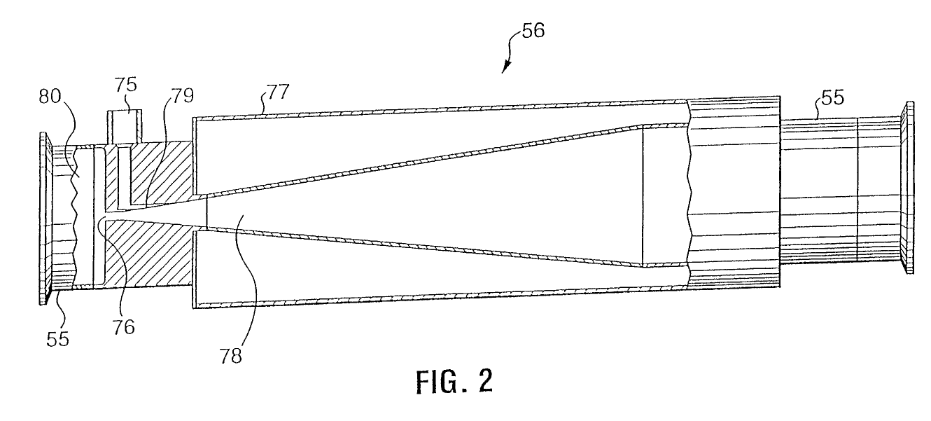

To carry out the processes described above, apparatus illustrated diagrammatically in FIGS. 1-2 may be employed.

Generally a storage tank 1 for holding one liquid protein source is placed at one end of the factory. In a preferred embodiment an additional storage tank 2 for holding an additional source of liquid protein or water will also be used. Finally, a collection tank 3 for a deproteinized liquid by-product, as shown in Figure lb can also be employed.

In the manufacture of cheese using whey, the whey is supplied from cheese tanks (not shown). The whey is cooled through a heat exchanger 73, and then pumped through an entry line 74. In the production of soft protein foods, the liquid protein sources and possibly water leave the supply tanks 1 and 2 through supply line 4. They pass through one-way valves 5, and are moved by way of pumps 6. Thereafter, the liquid protein sources are passed through flow meters 7. A ratio meter 8, by way of circuit lines 9, will determine the ratio of one liquid protein source to the other or to water, both of which will then pass into a single line called in-flow line 11. If required, cream can be added through cream port 10. The liquid protein and possibly cream or water passes into a mixing tank 12; thereafter, through an outlet port 13 and into outflow channel 14.

The mixed liquid protein from reservoir 12 is moved through flow channel 14 by way of pump 15. An alkali tank 16 and an alkali pump 17 are governed by pH controller 18 which senses the level of pH in the liquid protein by sensor 21. If the level of pH is too acidic, pH controller 18 sends alkali into the line 19 prior to static mixer 20. Additional ports 22 and 23 can be used for salt injection or sampling, respectively. Once the alkali has been added to the mixed liquid protein, the liquid protein travels along enclosed line 24 to the heat exchanger 25 where the liquid protein is heated. The source of heat can be by way of hot deproteinated liquid which is a waste by-product of the protein food making process. The hot deproteinized whey enters the heat exchanger through line 26. The hot deproteinized liquid is moved along line 26, as shown in FIGS. 1b and 1c, by pump 27 which connects the channel way with the deproteinized liquid collection tank 28.

Returning to FIG. 1b, an alternative and/or supplementary source of heat could be hot water line 29. The deproteinized liquid outflow line 30 will lead either to a sewer or to the deproteinized liquid storage tank 3. The heated liquid protein leaves the heat exchanger by line 31, where it passes by sample port 32, which will check the temperature. The temperature should be between 80 and 90° C. for the production of ricotta cheese.

The liquid protein, thereafter, passes through flow meter 33 to a one minute first holding tube 34. Generally the temperature is maintained. After the one minute of holding which ensures that the liquid protein is sanitary, the liquid protein will flow out line 35 past temperature gauge 36 through flow diversion meter 37, which is governed by control panel 38, and the liquid protein may either be diverted out return line 39 or continue on through outflow line 41 through divert panel 42 and outflow line 43.

In the manufacture of certain protein products, the liquid protein will next be diverted through a holding tube of predetermined length 44. There, the temperature of the liquid protein is maintained and becomes somewhat turbulent, causing the whey protein molecules to denature. The holding tube 44 may be insulated to keep the temperature up. Thereafter, the liquid protein flows through outflow line 45 past temperature gauge 46 and to outflow line 47.

At this point the salt may be added to the liquid protein from salt reservoir 48 which is filled with a solution of NaCl. A salt pump 49 will pump the salt to salt injection port 50. Thereafter, the liquid protein will pass to manifold 51 where it may pass into two or more coagulation lines 52, 53, 54, and 55. The apparatus shown indicates four coagulation lines 52, 53, 54 and 55. However, the number of lines can vary. The following description is meant to serve merely as an example using four lines. The coagulation lines have a much slower flow, and in fact have a laminar flow as opposed to the more turbulent flow in line 47. A coagulant from supply tank 57, generally in the form of lactic acid or cittric acid for the production of cheese, can be added through line 59 by way of pumps 60, 61, 62, and 63. Injectors 64, 65, 66, and 67, inject the coagulant respectively into laminar flow coagulation lines 55, 54, 53, and 52. Again the number of pumps and injectors as shown in FIG. four. However two or more pumps and injectors can be used, the number of each being equivalent to the number coagulation tubes.

The coagulant and liquid protein mix in a mixing chamber 56, which will be more fully described in conjunction with FIG. 2.

In order to conserve space, laminar flow lines 52, 53, 54 and 55, are coiled as shown as 68, 69, 70, and 71. Thereafter, the coagulated protein curds will exit the tour laminar lines at exit ports 81, 82, 83, and 84, and the coagulated protein will be transferred onto a draining conveyor 72. Conveyor 72 is made of a woven material which has small perforations which permits deproteinized liquid, which is a waste product, to descend into deproteinized liquid collection tank 28 and thereafter to be moved by a pump 27 back to the heat exchanger to heat new liquid protein.

FIG. 2 is a longitudinal partial cross section of the coagulant/liquid protein mixing chamber shown generally as 56. There is a coagulant injector 75 and a liquid protein entrance orifice 76 bored through plate 80. Line 55 is connected to the manifold 51 (not shown in FIG. 2).

The coagulant or organic acid, as is generally used for cheese, mixes at point 79 with the liquid protein, passing through orifice 76 in mixing venturi 78. The casing 77 is located around the mixing chamber. This configuration helps to more readily mix the coagulant with the liquid protein.

Finally, the coagulated protein, or curd in the case of making cheese, is removed from belt 72 into packing crates (not shown).

This invention presents for the first time a means by which a small producer can continuously produce acid-curd and whey cheeses, soyfood, casein, and other coagulated protein products with a minimal capital investment. Vats, high-temperature-short time (HTST) equipment are standard in many soft protein food factories and dairies with the current art providing a wide range of mechanisms for separating the coagulated protein from the liquid by-product, once the coagulated protein has been formed.

The conditions, amounts, and types of coagulant required for protein precipitation are described in the prior art. The present invention automates the process by eliminating the necessity of manually removing coagulated protein from the surface of the liquid and by ensuring uniform product quality. Parameters such as pumping rate, time and temperature of heating, acidification temperature, pH of acidification, coagulation temperature and coagulation time can be controlled precisely. This eliminates incomplete denaturation, production of cooked flavour and variations in coagulated protein pH, resulting in a product with optimal yield, uniform flavour, texture and composition.

The present invention incorporates flexibility and process parameters which are readily varied over a wide range to suit the characteristics desired in the final product:

(1) The soft protein manufacturer can select from a wide range of raw materials to prepare several types of protein products.

(2) Coagulated protein characteristics can be varied over a wide range. The addition of sodium chloride can be made at any point in the process and serves to firm coagulated proteins containing high percentages of denatured whey protein eg. blends of skimmilk. Prior art indicates that the curd can also be made firmer by the addition of soluble calcium salts and may be added at several points in the continuous flow process. In this invention, it was observed that for the production of low casein cheeses, dilution of the heated mixture, at the time of, or after acidification, with water, also serves to increase curd firmness and improve handling characteristics.

(3) pH of the coagulum can be precisely controlled and varied over a selected range. pH control and acid metering equipment can be installed in-line and be completely automated. The pH can be accurately set and precisely controlled to maximize coagulation and thus, product yield, for those protein products that use an acid as the coagulant.

(4) Ultra-high-temperature (UHT) equipment can be used to give a product with sterility. This equipment is normally supplied with deaeration that reduces entrapped air and dissolved gases. This results in fewer air bubbles, in the coagulation tube and in turn, favours better coagulation.

(5) The coagulated protein can be collected and separated from the liquid by-product by a variety of techniques at points removed from the production area. This allows for coagulated protein collection in areas designed to give low aerosol contamination and improve keeping quality of the finished product.

(6) Processing conditions can be varied within predetermined parameters thereby avoiding failure and product loss. The traditional processes may rely on air/gas entrapment to facilitate recovery of the product and occasionally failures result from the curd sinking. The present invention does not rely on air entrapment for curd recovery.

In order to assess the efficiency of removal of protein, fat and solids from the raw material in the final product, analyses were performed on starting, and finished materials, using official AOAC procedures (3). Non-protein-nitrogen (NPN), true protein, and proteose-peptone were determined by the Rowland procedure (21). Depletion of protein, fat and solids in the final separated liquid was considered a better index of recovery than actual weights of finished product, due to large equipment capacity and short processing times. For this reason, the process was evaluated from the standpoint of depletion of recoverable protein, solids and fat in the final separated liquid. Lactose, NPN and the proteose-peptone fraction are not concentrated in the final product and do not enter into the calculations when determining the depletion of protein or solids.

Examples 1 through 9 provide detailed information on product characteristics and depletion of the various components of the starting ingredients. The extensive depletion of fat, protein and solids translates into high recovery of these components and points to the effectiveness of the present invention in producing high yields of protein product on a continuous basis with relatively inexpensive equipment.

### EXAMPLES

### Example 1

Ricotta Cheese

A blend of 80% pasteurized whey and 20% raw milk, adjusted with pH 7.9 with sodium hydroxide containing 7.69% total solids, 1.26% protein and 1.0% milk fat was processed by continuous heating, acidification (citric acid), coagulation and curd separation. Transition times were 15 minutes for the heating phase (88.4 to 89.6° C.) and 10 minutes for protein coagulation upon citric acid addition (2.5% w/v). Depletion of the major components was as follows:

| Components | % Depletion |
|---|---|
| Milk fat | 93% |
| Protein (Casein, True whey | 95.5% |
| proteins & proteose peptone) | |

In this example the yield efficiency was 95.9% with an actual yield of 9.26for a cheese with a moisture content of 76.6%.

### Example 2

Ricotta Cheese

Ricotta cheese was prepared from a blend of 244.8 kg of whey (82.6% w/w) and 51.6 kg of skimmilk (17.4% w/w) adjusted from pH 6.4 to approximately pH 7.0 with sodium hydroxide and pasteurized at 89.4° C. for 20 min. The heat-treated product was continuously acidified with 2.5% citric acid (w/v) to reduce the pH to 5.38. The precipitated material and liquid were continuously passed through coagulation tubes of approxiately 4 cm diameter to exit on a continuous conveyer belt for separation of the curd and deproteinated whey. Depletion of the recoverable protein and solids was 89.6% and 95.8% respectively. Tile fresh curd contained 11.08% protein and 16.23% solids. After draining in a cold room (4° C.) for approximately 24 hr, the protein content was 13.16% and the solids 23.44%.

### Example 3

Ricotta Cheese

Ricotta cheese was prepared from a blend of 170 kg of whey (85% w/w) and 30 kg of whole milk (15% w/w) adjusted from pH 6.34 to approximately pH 7.0 with sodium hydroxide and pasteurized at 90° C. for 20 min. The heat-treated product was continuously acidified with 2.5% citric acid (w/v) to reduce the pH to 5.45. The precipitated material and liquid were continuously passed through coagulation tubes of approximately 4 cm diameter to exit on a continuous conveyor belt for separation of the curd and deproteinated whey. Depletion of the recoverable protein, solids and fat were 93.3, 93.7 and 100% respectively. The fresh curd contained 11.56% protein, 5.43% fat and 23.38% solids. After draining in a cold room (4° C.) for approximately 24 hr the protein content was 16.04%, fat 8.6% and solids 31.04%.

### Example 4

Goats Whole Milk Ricotta Cheese

Goats milk containing 3.57% total protein, 4.85% milk fat and 12.72% total solids was processed by continuous heating, acidification (citric acid), coagulation and curd separation. Transition times were 15 minutes for the heating phase (87.4 to 89° C.) and 10 minutes for protein coagulation, after citric acid addition. Depletion of the major components, was as follows:

| Components | % Depletion |
|---|---|
| Milk fat | 96.47 |
| Protein (Total) | 87.43 |
| Casein | 95.99 |
| Heat coagulable protein | 100.00 |
| Proteose peptone | 58.52 |

The actual yield of cheese was 44 kg from 258.6 kg of goats milk or 17%.

### Example 5

Goats Whole Milk Ricotta Cheese

Goats milk containing 3.0% total protein, 3.3% fat and 11.6% total solids was processed by continuous heating, acidification (lactic acid), coagulation and curd separation. Transition times were 15 minutes for the heating phase (90.2 to 91.8° C.) and 10 minutes for protein coagulation after lactic acid addition. Depletion of the major components were as follows:

| Components | % Depletion |
|---|---|
| Milk fat | 96.35 |
| Protein (Total) | 97.18 |
| Casein | 96.62 |
| Heat coagulable protein | 99.78 |
| Proteose peptone | 93.69 |

The actual yield of cheese was 54.0 kg from 322.4 kg of goats milk or 16.7%, with a moisture content of 61%. The projected yield using the type “K” yield formula (presented at the cheese Symposium, California Dairy Foods Research Centre, U. C. Davis, Feb. 13-14, 1995 by H. W. Modler) was 16.02% but due to inclusion of 93.69% of the proteose peptone component (0.24 g/100 g milk) the actual yield was higher. When the proteose peptone component is factored into the yield equation, the theoretical yield becomes 16.7% which is equal to the actual product yield.

### Example 6

Casein

Pasteurized skimmilk (53° C. for 30 minutes) containing 3.09% total protein, of which 2.35% was casein, was processed by continuously heating (48-50° C. for 1 minute), acidifying with lactic acid (3.36%), coagulating and then continuously separating the casein from the partially deproteinated whey on the same conveyor used for ricotta manufacture.

| Components | % Depletion |
|---|---|
| Total protein | 77.80 |
| Casein | 96.85 |
| Heat coagulable proteins | 13.77 |

In this example, whey protein denaturation was purposely reduced to prevent coprecipation with the casein component. The pasteurization process (63° C. for 30 minutes) does lead to some whey protein denaturation but less than 14% of the whey proteins were incorporated with the casein components, compared to over 90% for goats milk Ricotta, in example 4.

### Example 7

Tofu

Soybean milk containing 5.8% total solids, 2.76% protein and 1.42% fat was processed by continuous heating, addition of CaCl₂·2H₂O, coagulation and curd separation. Dwell times were 1 minute for the heating phase (95.2-95.8° C.) and 10 minutes for coagulation, after the addition of the calcium chloride dihydrate (1.89 g/L of soy milk). Depletion of the major components was as follows:

| Components | % Depletion |
|---|---|
| Total solids | 64.5 |
| Protein | 85.6 |
| Fat | 97.2 |

Yield of curd was 70.7 kg from 432.3 kg of soy milk or 16.35%. The resulting “firm” tofu contained 25.98% total solids, 14.61% protein and 8.56% fat.

### Example 8

Queso Blanco

Queso Blanco cheese was prepared from 376.4 kg of whole milk containing 12.97% total solids, 3.72% fat and 3.46% total protein. The whey proteins, in the milk, were continuously denatured by heating to temperatures as high as 100° C. and holding for 9.7 min. The heat-treatment product was Continuously acidified with 2.5w citric acid (w/v) to reduce the pH from 6.7 to 5.6. The precipitated material and liquid were continuously passed through coagulation tubes of approximately 4 cm diameter to exit on a continuous conveyor belt for separation of the curd and deproteinated whey. Depletion of the recoverable protein, solids and fat were 97.06%, 97.67% and 96.77% respectively. The fresh curd contained 17.8% protein, 18.21% fat and 40.93% solids. After draining in a cold room (4° C.) for approximately 24 hr the protein content was 21.18%, fat 22.01% and solids 47.44%.

### Example 9

Queso Blanco

Queso Blanco cheese was prepared from 125 kg of milk standardized to 2.88% butterfat and containing 12.04% total solids and 3.57% total protein. The whey proteins, in the milk, were denatured by heating to 82.2° C. for 20 min. The heat-treated product was continuously acidified with 2.5% citric acid (w/v) to reduce the pH from 6.7 to pH 5.4. The precipitated material and liquid were continuously passed through coagulation tubes of approximately 4 cm diameter to exit on a continuous conveyor belt for separation of the curd and deproteinated whey. Depletion of the recoverable protein, solids and fat were 96.9, 94.4 and 90.3% respectively. The fresh curd contained 19.42% protein, 10.62% fat and 35.82% solids. Alter draining for approximately 24 hr at 4° C., the protein content was 25.4%, fat 10.34% and solids 46.26%.

### Example 10

Tofu

Soymilk containing 4.83% total protein, 2.49% lipids and 9.57% total solids was diluted with water (50% w/w) and processed by continuous heating, acidification (magnesium chloride), coagulation and curd separation. Transition times were 1 minute for the heating phase (85 to 87° C.) and 10 minutes for protein coagulation, after magnesium chloride addition. Depletion of the major components, was as follows:

| Components | % Depletion |
|---|---|
| Lipids | 99.3 |
| Protein (Total) | 92.6 |
| Solids (Total) | 77.1 |

The actual yield of tofu was 29.7 kg from 98.5 kg of soymilk or 30%. The tofu contained 7.14% lipids, 11.16% total protein, and 19.75% total solids.

### Example 11

Tofu

Soymilk containing 4.54% total protein, 2.11% lipids and 8.07% total solids was processed by continuous heating, acidification (⅓ magnesium chloride & ⅔ calcium sulphate blend), coagulation and curd separation. Transition times were 1 minute for the heating phase (85 to 87° C.) and 10 minutes for protein coagulation, after magnesium chloride/calcium sulphate addition. Depletion of the major components, was as follows:

| Components | % Depletion |
|---|---|
| Lipids | 99.7 |
| Protein (Total) | 93.8 |
| Solids (Total) | 82.2 |

The actual yield of tofu was 39.1 kg of soymilk or 33%. The tofu contained 5.29% lipids, 9.56% total protein and 15.92% total solids.

### References

1. Alfa Laval. 1982. Alcurd continuous cheese coagulator. Bulletin no. PP62277E.

2. Anonymous. 1983. Sordi production line for Ricotta cheese. North. European Dairy J. (7):185-186.

3. Association of Official Analytical Chemists: Official Methods of Analysis. 12th Ed., Washington, D.C. (1975).

4. Calabro, J. 1930. The new, continuous and automated process for making Ricotta cheese. Proced. 17th Annual Marschall Invitational Italian Cheese Seminar. Madison, Wis. p. 39-44.

5. Carswell, D. R. 1973. Manufacture of Ricotta cheese. U.S. Pat. No. 3,780,199.

6. Cleary, P. J. and K. M. Nilson. 1983. Recovery of curd losses in Ricotta cheese using horizontal bed filtration. Am. Cultural Dairy Prod. J. 18(1):5-9.

7. Edwards, J. L. 1977. Method for manufacture of Ricotta cheese from skimpily. U.S. Pat. No. 4,020,186.

8. Grieg, R. I. W. 1379. The manufacture, properties and use of heat denatured whey protein. Milk Indust. 81(2):30-34.

9. Kosikowski, F. V. 1972. Precipitation phenomenon of Ricotta and related cheese. Dairy & Ice Cream Field 155(9):124-126.

10. Kosikowski, F. V. 1977. Cheese and fermented milk foods. pp. 138-194.

11. Kosikowski, F. V. 1977. Cheese and fermented milk foods. pp. 168-178.

12. Lavarda, J. 1972. Preparation of Ricotta cheese curd. L U.S. Pat. No. 3,704,136.

13. Maubois, J.-L. and F. V. Kosikowski. 1981. Continuous preparation of Ricotta cheese by membrane ultrafiltration. Brief Communications, Int. Dairy Congress. p. 791-792.

14. Morr, C. V. 1982. Functional properties of milk proteins and their use as food ingredients. In “Developments in Dairy Chemistry-1”. Fox, P. F. (ed.). Applied Sci. Publishing, London. pp. 375-399.

15. Nolan, A. L. 1983. New cheese process. Food Engineering. 55(8):100-101.

16. Panzer, C. C., E. F. Schoppet, H. I. Sinnamon and N. C. Aceto. 1976. Continuous coagulation of Cottage cheese. J. Food Sci., 41:1293-1296.

17. Parry, R. ll. 1980. Milk coagulation and protein denaturation. In “Fundamentals of Dairy Chemistry”. Webb, B. H., A. H. Johnson and J. A. Alford (ed.). AVI Publishing Co. Inc. Westport, Conn., Chapter 11.

18. Pontecorvo, N. 1973. Process for producing Ricotta cheese. U.S. Pat. No. 3,732,110.

19. Pontecorvo, N. E. 1973. Preparation of Ricotta cheese. U.S. Pat. No. 3,741,773.

20. Pontecorvo, N. E. 1974. Method and apparatus for preparation of Ricotta cheese. U.S. Pat. No. 3,836,634.

21. Rowland, S. J. 1938. The determination of the nitrogen distribution of milk. J. Dairy Res. 9(1):42-57.

22. Savarese, J. 1931. Continuous cheese making machine. U.S. Pat. No. 4,254,098.

23. Schmidt, H. G., K. G. Strauss and W. Schmidt. 1972. Manufacture of Ricotta type fresh cheese. Netherlands Patent 7,203,863.

24. Shahani, K. M. 1979. Newer techniques for making and utilization of Ricotta cheese. 16th Annual Marschall Invitational Italian Cheese Seminar. Madison, llis. pp. 77-87.

25. Snoeren, T. H. M., A. J. Damman and H. J Klor. 1902. The viscosity of skimmilk concentrates. Neth. Milk Dairy J. 36:305-316.

The embodiments of the invention in which an exclusive property or privilege is claimed are defined as follows:

1. An apparatus for making soft protein foods including:
a liquid protein supply tank;
an enclosed first channel-way communicating between the liquid protein supply tank and a heat exchanger;
at least one source of heat for the heat exchanger;
an enclosed second channel-way adapted to transport heated liquid protein from the heat exchanger to a first holding tube;
the first holding tube adapted, in operation, to maintain the heated liquid protein therein at a predetermined temperature for a prescribed period of time;
a third channel-way adapted to transport liquid protein between the holding tube and a manifold;
the manifold communicating with a plurality of enclosed coagulation lines, each coagulation line adapted, in operation, to permit coagulation of liquid protein therein to obtain coagulated protein and liquid waste;
a coagulant supply means and at least one injection means adapted to introduce coagulant from the coagulant supply means into each coagulation line, and the coagulation line being adapted, in operation, to deliver coagulated protein and liquid waste to an exit port;
means for separating the liquid waste from the coagulated protein delivered through the exit port; and
a plurality of pumps adapted, in operation, to transport liquid protein through the apparatus.

2. An apparatus according to claim 1, further including pH adjustment components comprising an alkali supply tank, an alkali inflow line, an alkali injection port, a pH sensor, a pH controller, and a static mixer; and
said components being adapted, in operation, to adjust the pH of said liquid protein delivered to the heat exchanger.

3. An apparatus according to claim 1 or 2, further including a salt water supply tank;
a salt water pump;
an inflow line; and
a salt water injection port for injecting the salt water into the liquid protein in the third channel-way.

4. An apparatus according to claim 1, 2, or 3, further including:
a liquid supply tank;
one metering means;
one enclosed channel-way for each of said two supply tanks;
a ratio meter adapted, in operation, to meter liquids from each of two supply tanks at a predetermined ratio; and
a blending tank being adapted, in operation, to mix liquids from each of two supply tanks, said tank further communicating with the heat exchanger.

5. An apparatus according to claim 4, for making soft cheeses, wherein one supply tank is for the supply of whey and the second supply tank is for the supply of milk.

6. An apparatus as claimed in any one of claims 2 to 5 including a second holding tube connected to receive heated liquid protein from the first holding tube;
said second holding tube being much greater in length than said first holding tube and, being insulated, wherein, a denaturation of whey protein is effected.

7. An apparatus as claimed in any one of claims 1 to 6 wherein a source of heat for said heat exchanger is the liquid waste which has been separated from the coagulated protein.

8. An apparatus according to claim 7 further including:
a waste recovery tank adapted, in operation, to receive the liquid waste from the separation means; and
a pump adapted, in operation, to move the liquid waste from said waste recovery tank to the heat exchanger.

9. An apparatus as claimed in any one of claims 1 to 8, wherein each of said coagulation lines is coiled within an insulated tank to conserve space and heat.

10. A method of making Ricotta cheese comprising the steps of:
continuously metering and measuring predetermined quantities and ratios of milk and whey;
mixing said milk and whey in a blending mixer;
adjusting the pH of the milk and whey mixture by the addition of alkali to a pH of approximately 6 to 8;
heating said mixture in a heat exchanger;
transporting said heated mixture through a first holding tube;
maintaining said heated mixture at approximately 80-100 degrees C. in said holding tube for about 1 minute;
moving said heated mixture to a second holding tube;
maintaining said mixture in said second holding tube at approximately 60-90 degrees C. for up to 20 minutes in order to denature said whey protein;
transporting said mixture through a manifold into a plurality of tubes;
in each said tube, adding food grade acidulant to said mixture in a predetermined quantity;
passing the acidulant and the mixture with a laminar flow coagulation tube to effect coagluation of the mixture into coagulated protein and deproteinized whey;
delivering said coagulated protein and deproteinized whey from said laminar flow tube; and
separating coagulated protein to provide the Ricotta cheese product.

11. A method of making tofu comprising the steps of:
measuring a predetermined quantity of a solution containing soymilk;
heating soymilk solution in a heat exchanger;
transporting said heated solution through a holding tube;
maintaining said heated solution at approximately 95° C. in said holding tube for about 1 minute;
transporting said solution through a manifold into a plurality of tubes;
in each said tube adding a food grade coagulant selected from the group consisting of mineral salt and organic acid, to said soymilk solution in a predetermined quantity;
passing the coagulant and the solution into a laminar flow coagulation tube to effect coagulation of the solution into coagulated soyfood and deproteinized liquid waste;
delivering the coagulated soyfood and deproteinized liquid waste from said laminar flow tube; and
separating coagulated soyfood to provide the tofu product.

12. A method of making casein comprising the steps of:
measuring a predetermined quantity of skim milk;
heating said skim milk in a heat exchanger;
transporting said heated skim milk through a holding tube;
maintaining said heated skim milk at approximately 29-48° C. in said holding tube for about 1 minute;
transporting said skim milk through a manifold into a plurality of tubes;
in each said tube, adding an acid selected from the group consisting of a mineral acid and an edible grade organic acid to said skim milk in a predetermined quantity;
passing the acid and the milk into a laminar flow coagulation tube to effect coagulation of the milk into coagulated protein and deproteinized whey;
delivering said coagulated protein and deproteinized whey from said laminar flow tube; and
separating coagulated product to provide the casein.

13. A method of making Queso blanco cheese comprising the steps of:
continuously metering and measuring predetermined quantities and ratios of milk and whey;
mixing said milk and whey in a blending mixer;
heating said mixture a heat exchanger;
transporting said heated mixture through a first holding tube;
maintaining said heated mixture at approximately 80-100 degrees C. in said holding tube for about 1 minute;
moving said heated mixture to a second holding tube;
maintaining said mixture in said second holding tube under predetermined temperature for up to 20 minutes in order to denature said whey protein;
transporting said mixture through a manifold into a plurality of tubes;
into each said tube adding food grade acidulant to said mixture in a predetermined quantity;
passing the acidulant and the mixture into a laminar flow coagulation tube to effect coagulation of the mixture into coagulated protein and deproteinized whey;
delivering said coagulated prtein and deproteinized whey from said laminar flow tube; and
separating coagulated protein to provide Queso blanco.
